(19) United States
(12) Patent Application Publication
(10) Pub. No.: US 2005/0258209 A1
(43) Pub. Date: Nov. 24, 2005

(54) Fastening device on bicycle rack for vehicles

(76) Inventor: Chiu-Kuei Wang, Yuan-Li Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/849,922

(22) Filed: May 21, 2004

(51) Int. Cl. B60R 9/00; B60R 11/00

(52) U.S. Cl. 224/500; 224/513; 224/924

(57) ABSTRACT

A fastening device for a bicycle rack connected to a vehicle includes a first part fixed on one of two support arms of the bicycle rack and a clamping portion is integrally formed on a top of the first part and includes two side portions located in separate from each other. A first hook and a second hook are respectively connected to an outside of the two side portions. A second part is connected across to the two side portions and has a plurality of first holes defined in a first end thereof. The first hook is engaged with one of the first holes. A plurality of second holes are defined through the second part and the second hook is engaged with one of the second holes.

### FIELD OF THE INVENTION

The present invention relates to a bicycle rack on vehicles, and more particularly, to a fastening device on the bicycle rack for adjustably fastening the bicycle frames to the bicycle rack.

### BACKGROUND OF THE INVENTION

A conventional bicycle rack attached to vehicles generally includes two support arms and each of which includes several recesses such that top tubes of the bicycles can be engaged with the recesses and supported on the support arms. Nevertheless, during riding of the vehicle, the bicycles need to be secured to the arms or the bicycles could drop from the support arms. Some users use ropes to fasten the top tubes to the support arms and the ropes are not reliable because the knots that the users made for securing the bicycles may be loosened due to the shaking. Some manufacturers develop fastening devices on the support arms. However, the conventional fastening devices generally have fixed sizes which can only be used for certain types of bicycles that have circular top tubes.

The present invention intends to provide a fastening device connected to the support arm of a bicycle rack and the fastening device can secure various types of bicycle frames.

### SUMMARY OF THE INVENTION

The present invention relates to a fastening device for a bicycle rack on vehicles and includes two a first part secured on one of two support arms of the bicycle rack. A clamping portion is integrally formed on a top of the first part and includes two side portions located in separate from each other. A first hook and a second hook are respectively connected to an outside of the two side portions. A second part is connected across to the two side portions and has a plurality of first holes defined in a first end thereof. The first hook is engaged with one of the first holes. A plurality of second holes are defined through the second part and the second hook is engaged with one of the second holes.

The primary object of the present invention is to provide a fastening device for bicycle rack and which is able to clamp bicycle frames with different sizes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle rack with the fastening device of the present invention connected to support arms of the rack;

FIG. 2 is a perspective view to show the fastening device of the present invention;

FIG. 3 is an exploded view to show the fastening device of the present invention;

FIG. 4A shows the slot in communication with the passage is narrower by threading the bolt;

FIG. 4B shows the slot in communication with the passage becomes wider by controlling the bolt;

FIG. 5A shows a small bicycle frame is clamped by the clamping portions of the fastening device of the present invention;

FIG. 5B shows a large bicycle frame is clamped by the clamping portions of the fastening device of the present invention, and

FIG. 6 shows the bicycle rack connected to a vehicle.

### DETAILED DESCRIPTION OF THE PREFERRED EMBODIMENT

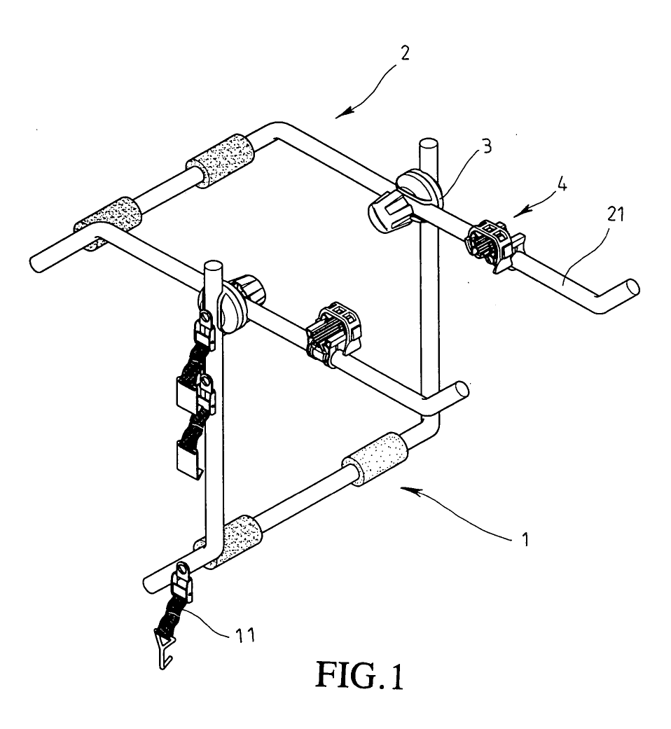

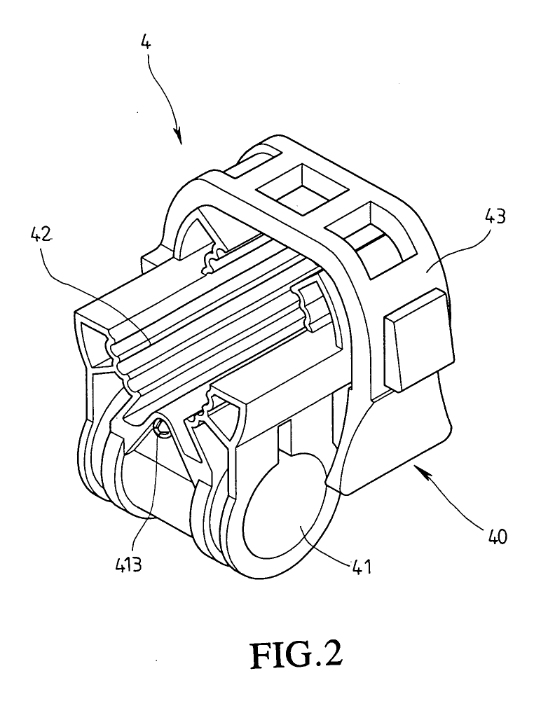

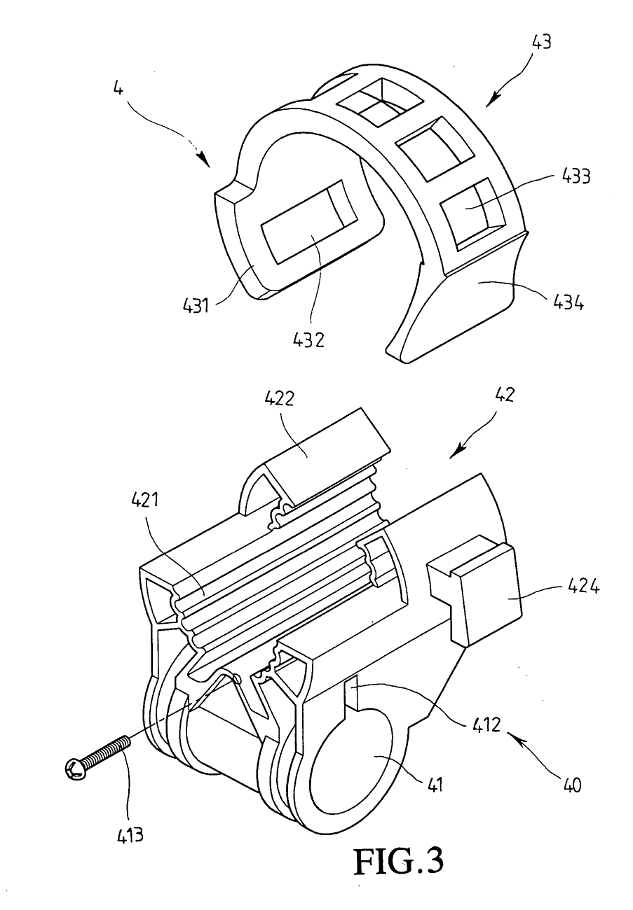

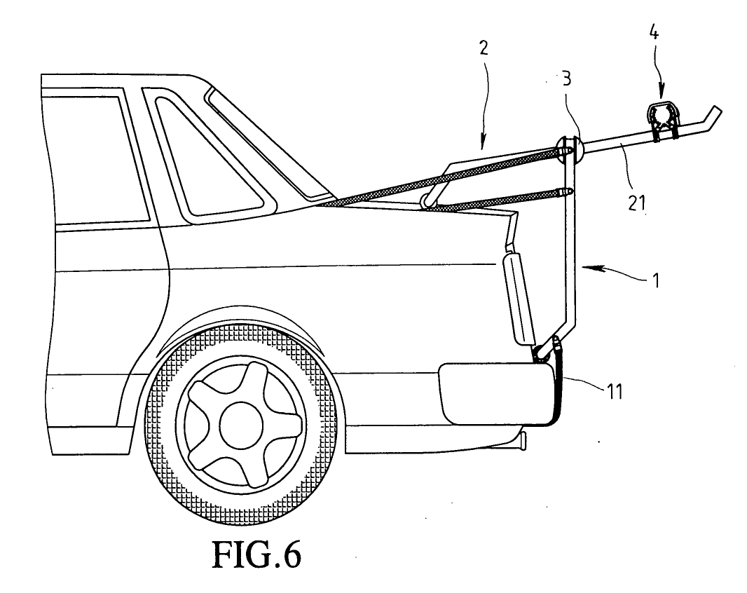

Referring to FIGS. 1, 2, 3 and 6, the bicycle rack 1 of the present invention comprises a U-shaped first frame 1 and a U-shaped second frame 2 which is pivotably connected to two legs of the first frame 1 by two adjustable devices 3. The second frame 2 includes two support arms 21 and each support arm 21 has a fastening device 4 connected thereto. Fastening belts 11 are connected to the first frame 1 and the second frame 2 so as to hook on the vehicle.

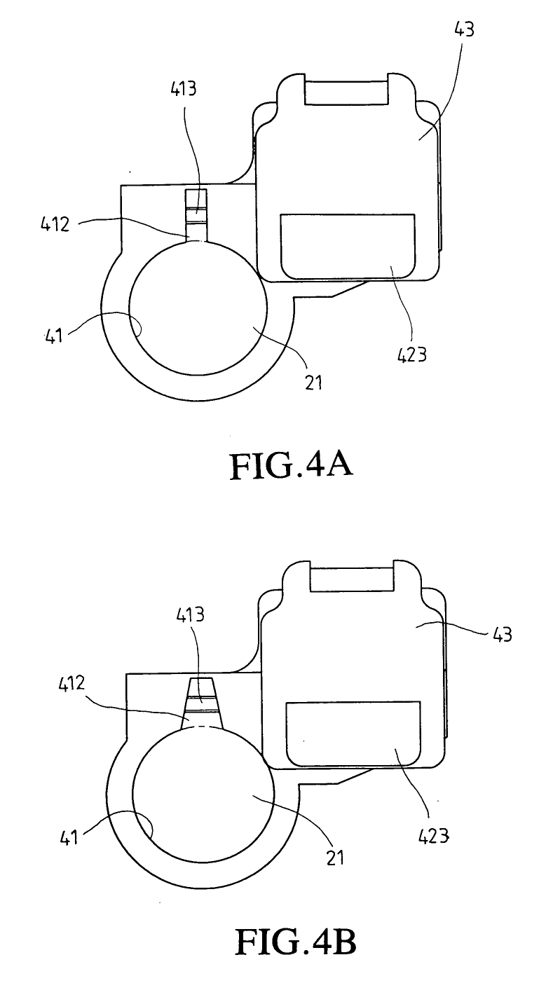

The fastening device 4 includes a first part 40 and a second part 43. The first part 40 includes a passage 41 defined therethrough such that one of the two support arms 21 extends therethrough. A slot 412 is defined radially in communicating with the passage 411 and extends along a longitudinal axis of the passage 41. A bolt 413 transversely extends through two banks separated by the slot 412 so as to adjust the inner diameter of the passage 41. As shown in FIGS. 4A and 4B, when the bolt 413 threads inward, the inner diameter of the passage 41 becomes smaller so as to secured to a smaller support arm 21. As shown in FIG. 4B, if rewinding the bolt 413 outward, the inner diameter of the passage 41 becomes bigger so as to secure to a larger support arm 21.

A clamping portion 42 is integrally formed on a top of the first part 41 and includes two side portions located in separate from each other. Each of the side portions of the clamping portion 42 has an extension part 422 extending from a top edge thereof so that when a bicycle frame 5 is clamped between the two side portions of the clamping portion 42, the extension parts 422 ensure that even an oval shaped frame can be well clamped. Each of the side portions of the clamping portion 42 and the extension parts 422 have a plurality of ridges and grooves defined in an inside thereof so as to increase the grasp force to the bicycle frame 5. A first hook 423 and a second hook 424 are respectively connected to an outside of the two side portions.

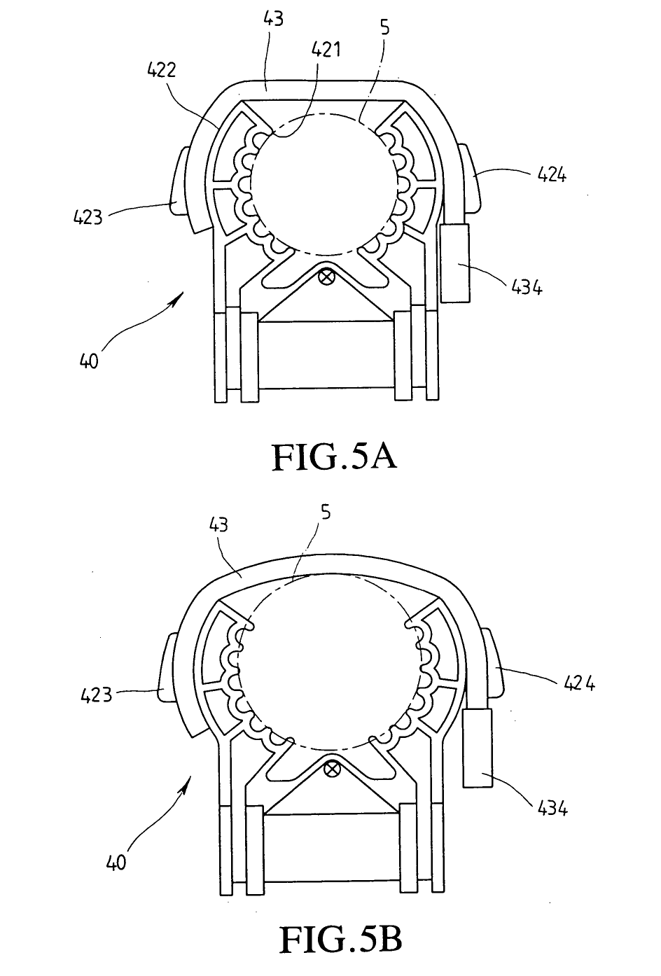

Further referring to FIGS. 5A and 5B, the second part 43 is made of flexible material and connected across to the two side portions. A plurality of first holes 432 are defined in a first end 431 of the second part 43 and the first hook 423 is engaged with one of the first holes 432. A plurality of second holes 433 are defined through the second part 43 and the second hook 424 is engaged with one of the second holes 433. A wide plate is formed to a second end 434 of the second part 43 such that the user may easily pull the second end of the second part 43.

The clamping portion 42 can be opened wider to accommodate a larger bicycle frame 5 and the extension parts 422 effectively clamp over half outer surface of the bicycle frame 5. The second part 43 is securely hooked to two the two side portions and ensure that the bicycle frame 5 can be then well secured.

While we have shown and described the embodiment in accordance with the present invention, it should be clear to those skilled in the art that further embodiments may be made without departing from the scope of the present invention.

1. A fastening device for a bicycle rack which is connected to a vehicle and includes two support arms for supporting bicycles thereon, the fastening device comprising:
a first part having a passage defined therethrough which is adapted to receive one of the two support arms therein, a clamping portion integrally formed on a top of the first part and including two side portions located in separate from each other, a first hook and a second hook respectively connected to an outside of the two side portions, and
a second part connected across to the two side portions and having a plurality of first holes defined in a first end thereof, the first hook engaged with one of the first holes, a plurality of second holes defined through the second part and the second hook engaged with one of the second holes.

2. The device as claimed in claim 1, wherein each of the side portions of the clamping portion has an extension part extending from a top edge thereof.

3. The device as claimed in claim 1, wherein each of the side portions of the clamping portion has a plurality of ridges and grooves defined in an inside thereof.

4. The device as claimed in claim 1 further comprising a slot defined radially in communicating with the passage and extending along a longitudinal axis of the passage, a bolt transversely extending through two banks separated by the slot.

5. The device as claimed in claim 1 further comprising a wide plate formed to a second end of the second part.

6. The device as claimed in claim 2, wherein each of the extension parts has ridges and grooves defined in an inside thereof.
